(19) United States
(12) Patent Application Publication
(10) Pub. No.: US 2014/0143752 A1
(43) Pub. Date: May 22, 2014

(54) SYSTEMS AND METHODS FOR PROVIDING ENVIRONMENTS AS A SERVICE

(71) Applicant: LEVEL 3 COMMUNICATIONS, LLC, Broomfield, CO (US)

(72) Inventors: Eric Alden Rumer, Erie, CO (US); Ken Rumer, Arvada, CO (US)

(73) Assignee: LEVEL 3 COMMUNICATIONS, LLC, Broomfield, CO (US)

(21) Appl. No.: 13/679,495

(22) Filed: Nov. 16, 2012

(51) Int. Cl. G06F 9/44

(52) U.S. Cl. 717/106

(57) ABSTRACT

Aspects of the present disclosure extend to methods and systems for providing computing environments as a service. In various aspects, hardware and/or software resources are automatically provisioned or otherwise allocated to support the different phases of a software development project. One or more interfaces may be accessed that allow for the selection and/or configuration of the various hardware and/or software resources corresponding to a software application and its current computing environment. The configured resources and source code may be provided as a service to users.

### TECHNICAL FIELD

Aspects of the present disclosure relate to provisioning and providing computing resources, and in particular, the automatic provisioning of various computing resources of a computing environment.

### BACKGROUND

Computing environments involve the integration of various computing resources used to run and execute application software. Typically, computing environments have distinct hardware and/or software characteristics and functionalities and may include numerous computing resources such as infrastructures, software binaries, file systems, databases, etc. Many different types of computing environments exist, such as development environments, testing environments, and/or production environments. A development environment includes the set of processes and programming tools used to develop a software application. A testing environment includes software and/or hardware for testing the newly developed software application. Finally, a production environment includes hardware and/or software for providing a “live” instance of the software application. For example, a production environment may include one or more software binaries, a database, and an application server, all of which may support the execution of the application software developed using the development environment and tested in the test environment.

Such computing environments cannot be easily and efficiently replaced, replicated, transferred, or re-allocated due to their complexity, size, and interconnections with other systems. Indeed, highly skilled developers and/or administrators are often required to manually deploy aspects of the computing environment to ensure the integrity of the environment is maintained, which is both time-consuming and expensive. It is with these problems in mind, among others, that various aspects of the present disclosure were conceived.

### SUMMARY

One aspect of the present disclosure involves a method for providing a computing environment as a service. The method includes initiating, using at least one processor, an instance of a service comprising source code being developed, the service corresponding to a first computing environment. The method also includes configuring, using the at least one processor, a plurality of resources of the service based on configuration information. The method includes promoting, using the at least one processor, the plurality of resources and the source code to a second computing environment.

Aspects of the present disclosure also include systems for providing a computing environment as a service. The system also includes at least one processor. The processor is configured to initiate an instance of a service including source code being developed, the service corresponding to a first computing environment. The processor is also configured to configure a plurality of resources of the service based on configuration information. The processor is configured to promote the plurality of resources and the source code to a second computing environment.

Aspects of the present disclosure also include anon-transitory computer readable medium encoded with a services application comprising modules executable by a processor. The modules include a service module to initiate an instance of a service comprising source code being developed, the service corresponding to a first computing environment and configure a plurality of resources of the service based on configuration information. The modules also include a promotion module to promote the plurality of resources and the source code to a second computing environment.

### BRIEF DESCRIPTION OF THE FIGURES

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 is an example computing environment for a services system in accordance with one aspect of the present disclosure.

FIG. 2 is a block diagram of a service system in accordance with one aspect of the present disclosure.

FIG. 3 is an example process for providing a computing environment as a service in accordance with one aspect of the present disclosure.

FIG. 4 is example of a services input form, according to aspects of the present disclosure.

FIG. 5 is another example of a continuous delivery input form, according to aspects of the present disclosure.

FIG. 6 is yet another example of a configuration management input form, according to aspects of the present disclosure.

FIG. 7 is example of a code promotion input form, according to aspects of the present disclosure.

### DETAILED DESCRIPTION

Aspects of the present disclosure extend to methods and systems for providing computing environments as a service. In various aspects, hardware and/or software resources are automatically provisioned or otherwise allocated to support the different phases of a software development project. Initially, one or more interfaces may be accessed that allow for the selection and/or configuration of the various hardware and/or software resources corresponding to the software development project and its current computing environment. Subsequently, the configured resources and source code may be provided as a service to users, thereby effectively offering the computing environment in its entirety as a service (herein referred to as “EaaS”).

A computing environment generally refers to the collection of various hardware and/or software computing resources used to develop, support, initiate, and/or execute a particular software application. For example, a production computing environment for a customer management application may include source code (i.e., source code for the customer management application) and various other hardware/software resources such as an application server, database, file systems, etc., all of which are required to properly execute the customer management application. Generally, computing environments are heterogeneous with different software and/or hardware characteristics. For example, the system hardware of a computing environment may vary in the number of processors, the size, arrangement and speed of the memory, the type of network connection, etc. Additionally, computing environments may employ different architectures and operating systems. Such environmental details contribute to determining whether an application will be able to properly execute within a given computing environment.

Moreover, when an application or the source code for an application is deployed or otherwise promoted from one computing environment to another computing environment (e.g., from a development environment to a test environment), it may not be known whether the characteristics of the underlying computing resources of the new computing environment are the same as, or compatible with, the former computing environment. When the compatibility is unknown, it is not known whether the application will execute differently or incorrectly in the new environment. Accordingly, in conventional environments, the process of preparing an application for execution within a particular, and perhaps initially unknown, computing environment is often labor intensive and time-consuming, and generally requires users to manually audit and prepare the resources within a computing environment to ensure that a given application will execute successfully.

Aspects of the present disclosure efficiently manage the configuration and deployment of various resources of a computing environment automatically, in the form of one or more services, thereby allowing users to transmit application and/or associated source code from one computing environment to another computer environment automatically and on-demand. Aspects of the present disclosure involve the delivery of centrally located software and/or hardware resources that are involved in providing the various computing environments discussed herein to users over a network, such as the Internet. By offering software and/or resources as services, users do not have to address the complexities of procuring and managing the underlying physical hardware and/or software layers required to deliver the service. Accordingly, an EaaS represents a delivery model in which all, or at least a substantial portion of, the software, data, infrastructures, etc., within a particular computing environment are delivered or otherwise provided to users, on-demand, as a fully functioning computing environment in the form of a service.

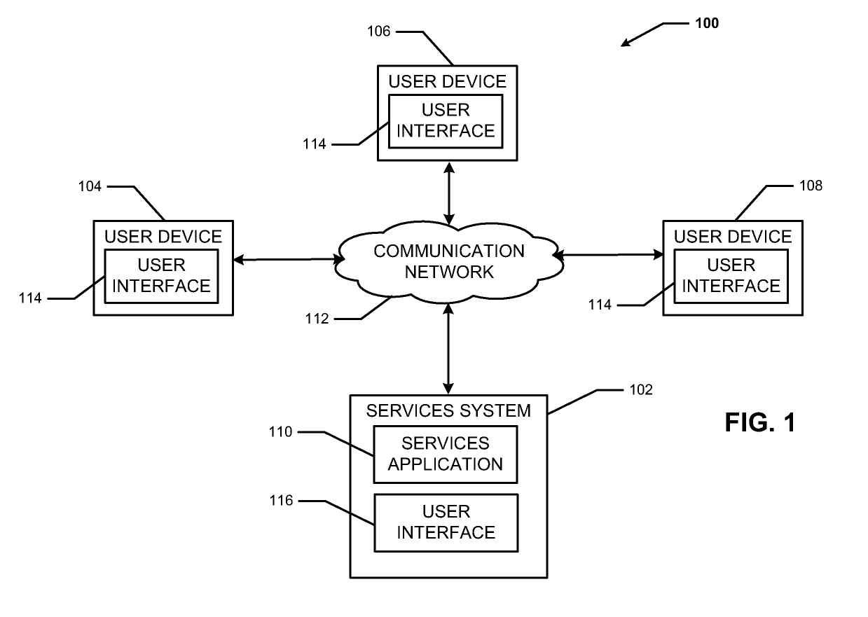

FIG. 1 illustrates an example computing environment 100 for enabling the automatic provisioning and/or configuration of various aspects of a computing environment as a service. A user, such as a developer, programmer, and/or information technology administrator, intending to access and/or provision a service, may interact with user devices 104-108 to provide configuration information to a services system 102. The configuration information may describe how the various hardware/software components of the services should be configured or otherwise provisioned. Generally, “provisioning” describes the process of preparing, establishing and/or otherwise configuring computing resources to perform and/or function in a particular manner. For example, provisioning a computing resource may include: installing, uninstalling, configuring, upgrading, and/or updating various software components and/or hardware components of, and/or associated with, the specific computing resource being provisioned. In some instances, provisioning systems are used to provision computing resources and provide interfaces, such as graphical user interfaces, that allow users to define and execute provisioning procedures, such as provisioning scripts and/or workflow processes. Provisioning scripts are a sequence of pre-defined provisioning instructions.

The user devices 104-108 may be a personal computer, work station, server, mobile device, mobile phone, tablet device, processor, and/or other processing device. Each device may include one or more processors that process software or other machine-readable instructions and may include a memory to store the software or other machine-readable instructions and data. The memory may include volatile and/or non-volatile memory. Additionally, each device may also include a communication system to communicate via a wireline and/or wireless communications, such as through the Internet, an intranet, an Ethernet network, a wireline network, a wireless network, a mobile communications network, and/or another communication network.

The user devices 104-108 may include a user-interface (UI) 114 for a user to provide input, such as configuration information for provisioning and/or configuring various aspects of a computing environment as a service. UI 114 may include a display (not shown) such as a computer monitor, liquid crystal display, for viewing data and/or input forms, and any combination of input/output devices (not shown), such as a keyboard, or a pointing device (e.g., a mouse, trackball, pen, or touch pad), speaker, and/or any other type of device for receiving input. For example, a developer may use one or more of the user devices 104-108 to access a service provisioned by the services system 102.

The user devices 104-108 may communicate with the services system 102 to provide the input received at the one or more user devices 104-108. The services system 102, which will involve at least one processor deployed in a personal computer, work station, server, mobile device, mobile phone, tablet device, and/or other processing device, may execute a services application 110 that processes input received from the one or more user devices 104-108 to generate services. The processors of the services system 102 include software or other machine-readable instructions, such as the services application 110, and may include a memory to store the software or other machine-readable instructions and data. The memory may include volatile and/or non-volatile memory. Additionally, the services system 102 may also include a communication system to communicate via a wireline and/or wireless communication, such as through the Internet, an intranet, an Ethernet network, a wireline network, a wireless network, a mobile communications network, and/or other communication network.

The services system 102 may include a second user-interface (UI) 116 to receive input from a user. UI 116 may include a display (not shown) such as a computer monitor, liquid crystal display, for viewing data and/or input forms, and any combination of input/output devices (not shown), such as a keyboard, or a pointing device (e.g., a mouse, trackball, pen, or touch pad), speaker, and/or any other type of device for receiving input and may function similar to UI(s) 114. For example, a developer may interact with the UI 116 to access a service.

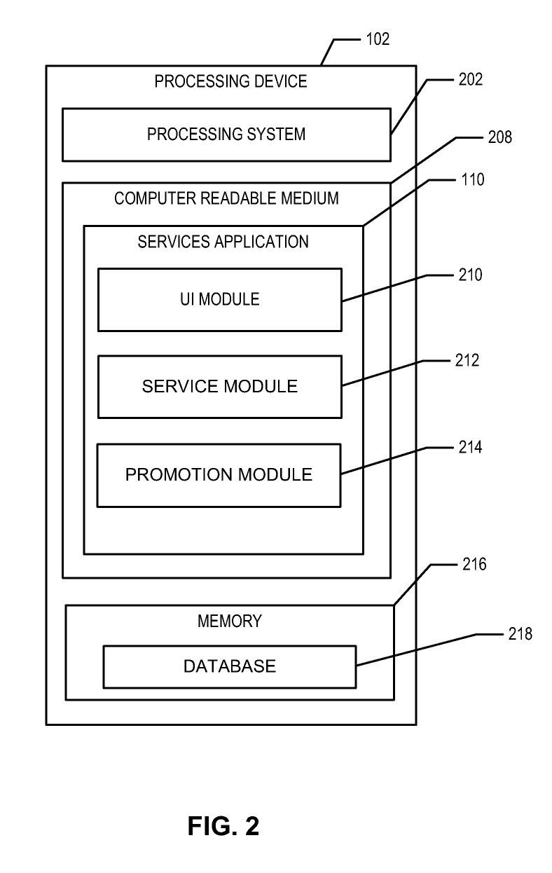

FIG. 2 is a block diagram illustrating the services system 102 according to aspects of the present disclosure. The services system 102 includes a processing system 202 that may be used to execute the services system 102 to provision a service. The processing system 202 may be in communication with a memory 216. The memory 216 may include volatile and/or non-volatile memory, and provides a database 218 to store data. According to one aspect, database 218 is a general repository of data including, but not limited to, configuration information. The database 218 may include memory and one or more processors or processing systems to receive, process, query and transmit communications and store and retrieve data. In another aspect, the database 218 may be a database server. In one particular embodiment, the database may be a content management database system and/or server.

The services system 102 may include a computer readable media (“CRM”) 208, which may include computer storage media, communication media, and/or another available computer readable medium that may store executable instructions to implement the services application 110 and/or associated functions, processes, etc. For example, CRM 208 may include non-transient computer storage media and communication media. By way of example and not limitation, computer storage media includes memory, volatile media, non-volatile media, removable media, and/or non-removable media implemented in a method or technology for storage of information, such as machine/computer-readable/executable instructions, data structures, program modules, or other data. Communication media includes machine/computer-readable/executable instructions, data structures, program modules, or other data. Generally, program modules include routines, programs, instructions, objects, components, data structures, etc., that perform particular tasks or implement particular abstract data types.

Referring now to FIGS. 1-3, in one particular embodiment, the services system 102 may launch, run, execute, interpret, or otherwise perform the logical instructions and/or processes of the services application 110 to provision a service, such as process 300, which depicts an example method and/or process for generating or otherwise provisioning one or more computing environments as a service. The process begins with receiving configuration input corresponding to a particular software application or active development project (operation 302). The configuration input may be received from various user interface input forms displayed at the user devices 104-108 and/or services system 102. For example, as illustrated in FIG. 2, a UI module 210 may transmit instructions that may be processed and/or executed to display one or more of the input forms for receiving configuration input. The input forms may include various interactive components, such as buttons, forms, fields, selections, inputs, streams, etc., for receiving the configuration input. In response, a user, such as a developer, may interact with the various components of the input forms to provide configuration information input data. For example, a user may provide configuration information describing an Information Technology support application and its various functionalities. As another example, a user may provide configuration input describing the development of a new networking optimization application.

Once a development project has been described, a service is generated (operation 304). For example, as illustrated in FIG. 2, a service module 212 may process the input received by the UI module 210 to automatically generate a service corresponding to the application or development project. In particular, the provisioning module may provision one or more software and/or hardware components required by the development project or application. In one particular embodiment, an integrated development environment (“IDE”) may be automatically provisioned. An IDE represents a software application that may provide various functionalities to computer programmers that may be used for software development. For example, a typical IDE may include a source code editor, build automation software tools, a software debugger, etc. Other functionalities and facilities may also be included. The configured IDE may be a commercially available IDE such as Eclipse™, Net Beans™, Visual Studio™, etc., or any type of IDE.

A source code repository may be automatically provisioned by the service module 212. A source code represents the collection of source code used to build, develop, and/or otherwise implement the particular application to which the service corresponds. The code repository describes the particulars of the location, privacy settings, and manner of which such source code may be stored and processed. For example, the code repository may be a Git, CVS, Concurrent Versioning System, or Subversion repository, or any other type of code repository or code management system.

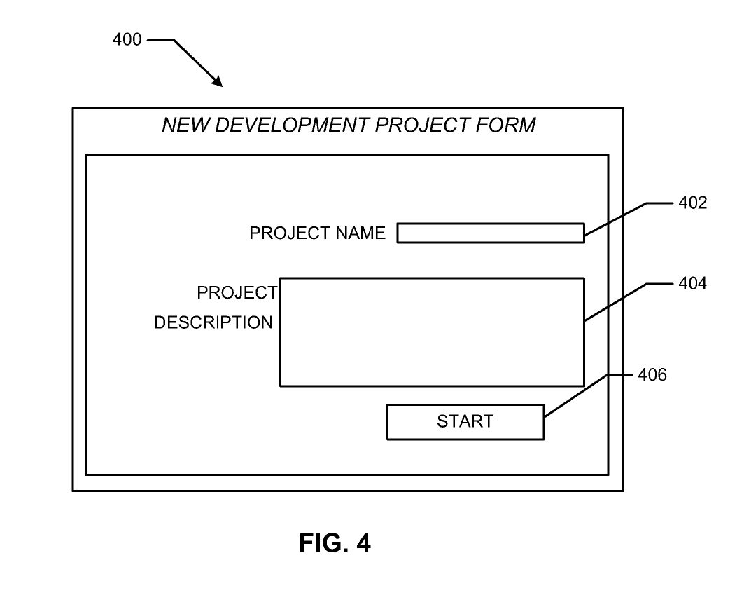

FIG. 4 represents an illustrative example of an input form for generating a service for a particular software application or development project based on configuration information received by the UI module 210. Assume, for example, a retail business user desires to develop a Pricing API application for an existing database that includes all of the user's pricing data for products sold over the last ten years. An application programming interface is a specification intended to be used as an interface by other software components to communicate. Accordingly, the Pricing API application provides an interface to access the existing pricing database. The user may enter various mouse clicks and/or keystrokes to provide a name for the development project and/or application to input field 402, such as the name “Pricing API Service” and corresponding configuration data including a description of the application or project to input field 404.

Subsequently, the user may select the “Start” button 406 to initiate one or more instances of the service. A user may initiate one or more service instances to perform one or more tasks, such as edit source code stored within the source code repository of the service or generate an instance of the service corresponding to the particular computing environment. Stated differently, when a service instance is initiated, the actual pieces of hardware and/or software are provisioned (i.e. an IDE, code repository, etc.) that collectively provide a fully functioning computing environment corresponding to the service. A service instance is provisioned when a new project or development is initiated. The newly initiated service instance may be in the development environment and every time the source code is changed, updated, maintained, etc., the code may be deployed to the development environment. The development environment may be promoted over time to the production environment.

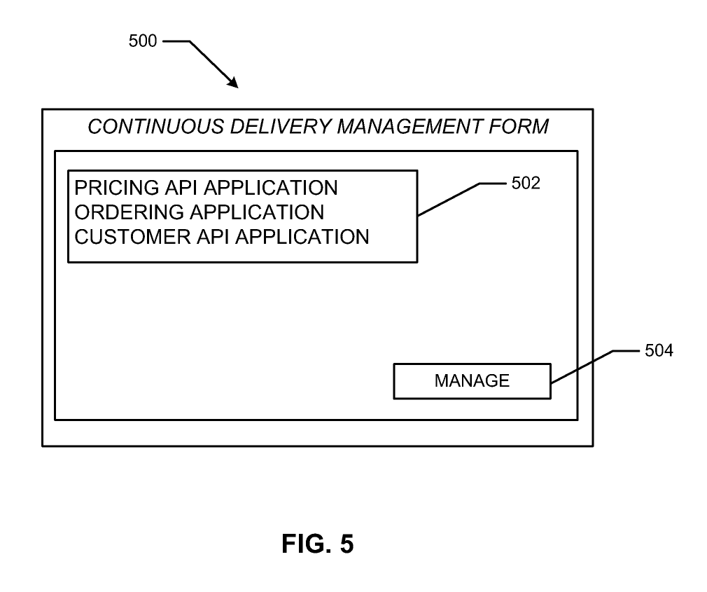

Alternatively, once a service has been generated and an instance initiated, the services and the various computing resources used to implement the service may be managed. For example, referring to the Pricing API application, the user may select an initiated instance of the Pricing API application service to access the various computing components used to implement the service, such a database and an application server. Subsequently, the user may, for example, reconfigure or activate/deactivate such components, etc. FIG. 5 represents an illustrative example of an input form 500 generated by the UI module 210. The form, referred to in this example as a “continuous delivery management” form, provides for initiating an instance of a service. For example, as shown in FIG. 5, one or more generated services, such as the Pricing API application service, may be selected at 502 and subsequently managed at 504.

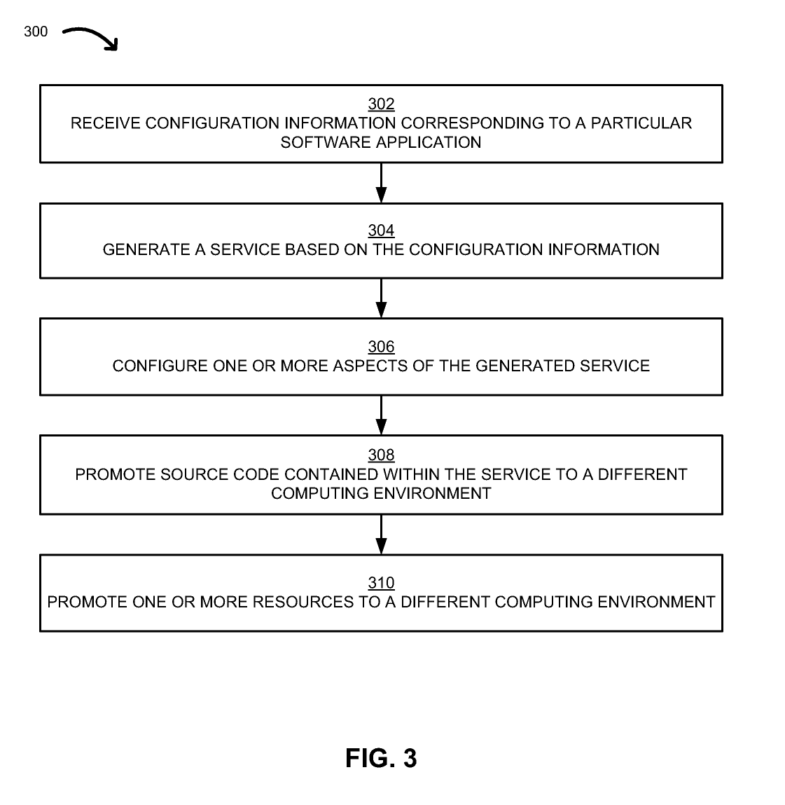

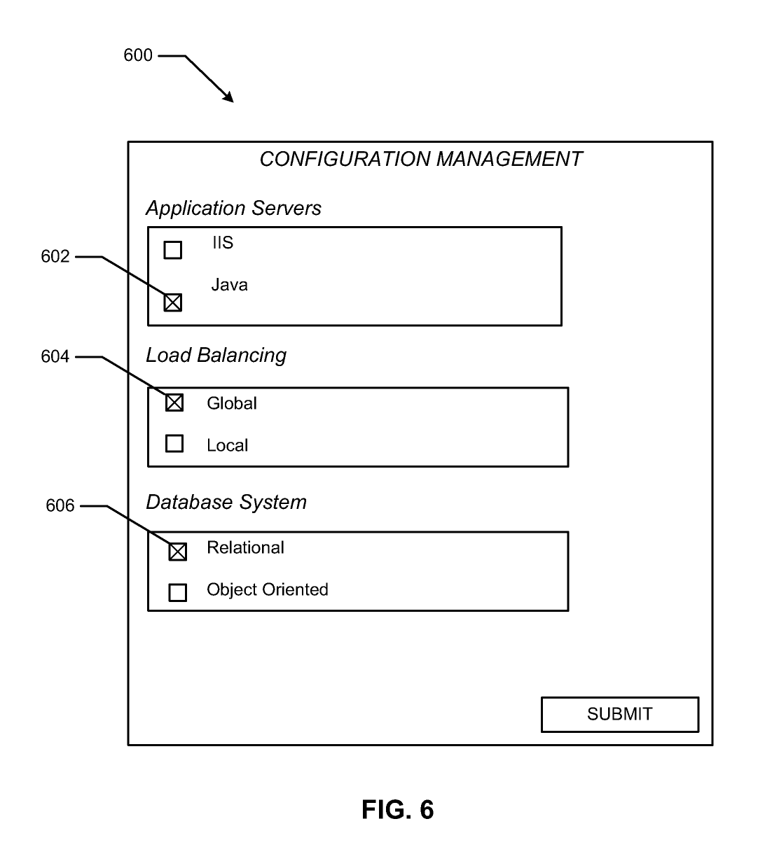

Referring again to FIG. 3, a user may optionally configure one or more aspects of the service generated by the service module 212 (operation 306). Specifically, the UI module 210 may transmit instructions that may be processed and/or executed to display one or more input forms on the user devices 104-108 and/or the services system 102 to be used for configuring aspects of a service. FIG. 6, referred to as the “Configuration Management” (“CM”) forms is an illustrative example of an input form for selecting and configuring various aspects of services.

The CM input forms may include various components that facilitate the provisioning of an application server and various characteristics and/or configurations of the application server. For example, the input forms may allow a user to configure the security, data services, transaction support, and/or load balancing characteristics of the application server. The configured application server(s) may be a commercially available application server such as Java® Platform, Enterprise Edition, Microsoft .Net Framework, Windows Server, TNAPS Application Server, IBM WebSphere Application Server, etc. As shown in FIG. 6, for example, a user may select to provision a Java® based application server 602. Additionally, the CM input forms may allow for the selection and/or configuration of various networking methodologies, such as whether to use global 604 or local load balancing. Load balancing, generally speaking, is a computer network methodology used to distribute workloads across a network. Global load balancing, more specifically, is a methodology used to distribute workloads across servers within a network located at different geo-locations. In contrast, local load balancing refers to a methodology used to distribute workloads within a local network, such as a virtual private network.

The CM input forms may also allow for the selection and/or configuration of a database, such as allowing a user to provision a hierarchical database, network database, relational database, object-oriented database, and or any other type of database that may be required. For example, as shown in FIG. 6, a user may provision a relational database system 606. The CM input forms may allow for the selection of a particular file system and one or more external services. For example, a user may select a disk file system, such as FAT, NTFS, HFS, etc. Alternatively, the user may select a flash file system and/or a database file system, transactional file systems, network file systems, etc.

The CM input forms may configure one or more external services. An external reference is a reference from one model file to an object in another model file. Referring to the pricing application example, an external reference may be implemented that provides access to an external “costing” application to provide cost related data and information to the pricing application.

Referring again to the Pricing API service example, a user may interact with the one or more user devices 104-108 to enter various mouse clicks and/or keystrokes as prompted by one or more input forms transmitted by the UI module 210 to provide input indicating that the user desires a computing environment including a relational database implementing a relational database management system. Additionally, the user may select to provision a Java® based application server capable of performing global load balancing. The user may select a FAT file system, and a Network File System as a distributed network file system, both of which are required by the Pricing API application.

Referring again to FIG. 3, after a service is configured, code contained within the code repository of a service may be promoted, transmitted, pushed, moved etc., from a service to a computing environment (operation 308). As shown in FIG. 2, a promotion module 214 may promote or otherwise transmit code corresponding to the application defined within the service accessed by the service module 212 from one environment to another environment, such as from a development environment to a test environment. As another example, code may be promoted, transmitted, etc., from a test environment to a production environment. It is contemplated that the promotion module may transfer code from one environment to any different environment and may transfer code from one environment to multiple different environments.

A continuous integration server may be provisioned and/or otherwise configured. The continuous integration sever may include software and/or hardware components capable of frequently integrating new or changed code within the code repository. For example, the continuous integration server may implement or otherwise configure one or more “hooks” upon code deployment and/or code promotion. A “hook” represents an end-point for other integrated applications and data points. Endpoints are a construct through which messages are sent or received (or both). Generally, endpoints include a location (an address) that defines where messages can be sent, a specification of the communication mechanism (a binding) that described how messages should be sent, and a definition for a set of messages that can be sent or received (or both) at that location (a service contract) that describes what message can be sent. An application endpoint represents an endpoint exposed by the application and that corresponds to a service contract implemented by an application.

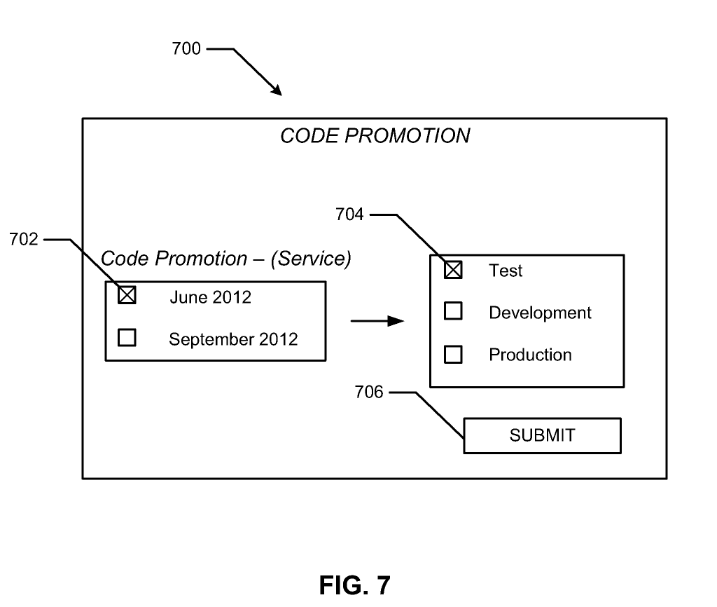

FIG. 7 provides an illustrative example of an input form for promoting code for a selected Service Instance, referred to as a “Code Promotion” input form. As illustrated, a user, such as a developer, may enter various mouse clicks and/or keystrokes to select a June 2012 version of the code 702 and indicate that the code should be deployed to a test computing environment 704. Referring to the Pricing API example, a user may promote code from a development environment to a test environment after all an initial version of the Pricing API application has been developed, and is ready for testing.

Each service (i.e. its code and computing resources) may also be deployed and/or otherwise transferred to an appropriate computing environment (operation 310). For example, as illustrated in FIG. 2, the promotion module 214 may deploy, send, transmit, copy and transmit, promote and/or otherwise provide one or more of the hardware and/or software resources of the service to an appropriate computing environment. Each resource of the service may be promoted to the appropriate computing environment in the form of a container. A container represents an object that contains a collection of data, software components, configurations, functionalities, etc., and may include an interface for accessing such. Accordingly, any aspect of a service instance, such as a database, application server, operating system, and/or any other supporting software, may be stored within a container, and subsequently deployed to a particular computing environment. In one particular embodiment, a container represents a single instance of an application server. Multiple containers are equivalent to an application cluster. An application cluster and/or a database, data store, etc., are equivalent to a instance of the service currently being transferred.

Referring again to the Pricing API application example, the promotion module 214 may promote or initiate the promotion of a database of the Pricing API application from a development environment to a production environment. Alternatively, in yet another example, the promotion module 214 may automatically promote a service of a Pricing API application from a development environment to a test environment. It is contemplated that that the promotion module 214 may provide services from any environment used as part of a development process to another different environment of the same development process, and further, that multiple services may be promoted, deployed, provided, etc.

An illustrative example of various aspects of the present disclosure will now be provided. A user, interested in developing a software application for accessing customer data, may interact with the user device 104 to provide configuration information describing the development of a new Customer Management Application (“CMA”). The services application 110 may process the configuration information to generate a new service corresponding to the CMA and automatically provision an integrated development environment and a corresponding source code repository, both of which may be used for the development of the CMA. The user may interact with various input forms generated by the services application 110 to initiate an instance of the CMA service and subsequently configure one or more software and/or hardware components corresponding to the CMA service, such as a relational database for storing customer information. Once the development environment, code repository, and database have been provisioned, the user may begin developing source code for the CMA.

Eventually, it may become necessary to test the newly developed CMA application. Accordingly, the user may interact with various input forms of the services application 110 to promote or otherwise transmit the CMA source code to a test environment for testing. Thus, the user may interact with the user device 104 to provide input to various input forms generated by the services application to promote the source code to a testing environment. Additionally, in order to properly test the CMA application, various resources of the development environment may need to be transmitted to the testing environment. For example, the test environment may need access to the relational database storing the customer information. Thus, the user may interact with the user device 104 to provide input to various input forms generated by the services application 110 to promote or transmit the relational database including customer information to the test environment. Subsequently, testers may perform various kinds of tests and/or execute numerous test cases on the CMA source code to any identify potential bugs. Users, such as developers and testers may access the various forms and interfaces of the services application 110 to promote the source code and any necessary resources from the development environment to the test environment and vice versa, on-demand as necessary, thereby offering each respective computing environment as a service.

When it is determined that the source code of the CMA has been sufficiently tested, a user may access the various form and interfaces of the services application 110 to promote or transmit the source code and any required resources to a production environment. For example, the user may interact with the user device 104 to provide input to various input forms generated by the services application 110 to promote or transmit the relational database including customer information the tested source code of the CMA to the production environment. The production environment may include various resources to provide a “live” instance of the CMA application to users. Accordingly, various users may access the CMA application within the production environment.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for providing a computing environment as a service comprising:
initiating, using at least one processor, an instance of a service comprising source code being developed, the service corresponding to a first computing environment;
configuring, using the at least one processor, a plurality of resources of the service based on configuration information; and
promoting, using the at least one processor, the plurality of resources and the source code to a second computing environment.

2. The method of claim 1, wherein initiating an instance of a service comprises automatically provisioning an integrated development environment for developing the source code and a code repository to contain the source code.

3. The method of claim 1, wherein the plurality of resources comprises a database and an application server.

4. The method of claim 3, further comprising receiving the configuration information via one or more input forms displayed at a user interface, the one or more input forms comprising one or more interactive components for configuring the database and the application server.

5. The method of claim 1, wherein promoting the plurality of resources comprises promoting the resources as a container.

6. The method of claim 1 wherein promoting the source code comprises executing a work flow to automatically promote the plurality of resources to the second computing environment.

7. The method of claim 1 wherein promoting the source code comprises provisioning a continuous integration server to promote the source code.

8. A system for providing a computing environment as a service comprising:
at least one processor to:
initiate an instance of a service including source code being developed, the service corresponding to a first computing environment;
configure a plurality of resources of the service based on configuration information; and
promote the plurality of resources and the source code to a second computing environment.

9. The system of claim 8, wherein to initiate an instance of a service comprises automatically provisioning an integrated development environment for developing the source code and a code repository to contain the source code.

10. The system of claim 8, wherein the plurality of resources comprises a database and an application server.

11. The system of claim 10, wherein the at least one processor is further configured to receive the configuration information via one or more input forms displayed at a user interface, the one or more input forms comprising one or more interactive components for configuring the database and the application server.

12. The system of claim 8, wherein to promote the plurality of resources comprises promoting the resources as a container.

13. The system of claim 8, wherein to promote the source code comprises executing a work flow to automatically promote the plurality of resources to the second computing environment.

14. The system of claim 8, wherein to promote the source code comprises provisioning a continuous integration server to promote the source code.

15. A non-transitory computer readable medium encoded with a services application comprising modules executable by a processor, the modules comprising:
a service module to:
initiate an instance of a service comprising source code being developed, the service corresponding to a first computing environment; and
configure a plurality of resources of the service based on configuration information; and
a promotion module to promote the plurality of resources and the source code to a second computing environment.

16. The non-transitory computer readable medium of claim 15, wherein to initiate an instance of a service comprises automatically provisioning an integrated development environment for developing the source code and a code repository to contain the source code.

17. The non-transitory computer readable medium of claim 15, wherein the plurality of resources comprises a database and an application server.

18. The non-transitory computer readable medium of claim 17, wherein the at least one processor is further configured to receive the configuration information via one or input forms displayed at a user interface, the one or more input forms comprising one or more interactive components for configuring the database and the application server.

19. The non-transitory computer readable medium of claim 15, wherein to promote the plurality of resources comprises promoting the plurality of resources as a container.

20. The non-transitory computer readable medium of claim 15, wherein the promotion module is configured to promote the source code by executing flow to automatically promote the plurality of resources to the second computing environment.
